(19) United States
(12) Patent Application Publication
(10) Pub. No.: US 2012/0187108 A1
(43) Pub. Date: Jul. 26, 2012

(54) ASSEMBLY, DEVICE AND METHOD FOR ATTACHING A CONTACT TUBE TO A SHAFT OF A CONTINUOUS RESISTANCE ANNEALER FOR WIRES

(76) Inventors: Rainer Schwarz, Schwabach (DE); Gerhard Herbst, Rednitzhembach (DE)

(21) Appl. No.: 13/147,726

(22) PCT Filed: Nov. 24, 2009
(86) PCT No.: PCT/EP2009/008359

§ 371 Date: Sep. 20, 2011

(30) Foreign Application Priority Data
Feb. 12, 2009 (DE) 102009008695.1

(51) Int. Cl. H05B 3/06; F16B 7/00; B23P 11/00

(52) U.S. Cl. 219/536; 29/428; 403/202

(57) ABSTRACT

An arrangement is provided for attaching a contact tube to a shaft of a continuous resistance annealing system for wires, wherein a centered flange is mounted on one end of the shaft, the flange including ring attachment structures for shaft-centered attachment of a ring to the flange. The ring includes tube attachment structures for ring-centered attachment of the contact tube to the ring and flange attachment structures for shaft-centered attachment of the ring to the flange. In the method for attaching a contact tube to a shaft of a continuous resistance annealing system for wires, a corresponding arrangement is constructed. To this end, the contact tube is attached to the ring in a ring-centered manner by the tube attachment structures, if the attachment has not already taken place. The ring is subsequently attached to the flange in shaft-centered manner by means of the ring attachment structures and the flange attachment structures.

The invention relates to an assembly, a device and a method for attaching a contact tube to a shaft of a continuous resistance annealer for wires. Continuous resistance annealing systems are used for the production of wires.

When drawing wire, a rough wire, which is generated by means of rolling, for example, is drawn through the tapering opening of a drawing plate or drawing die. In the process, the wire becomes longer and thinner. From one stage to another, the wire is drawn frequently through ever smaller openings until it finally has the desired dimension—in the case of a wire having a circular cross-section, this is the desired diameter.

In industrial production, the wire is drawn from a capstan through the drawing die. With each drawing cycle, the wire becomes thinner and longer—with the volume remaining the same. Because the wire material is rigidified during the drawing operation, a risk of tearing exists beyond a limit value. The degree of drawing is thus limited. The wire can frequently only be drawn further after a heat treating step. Continuous wire annealers are used for heat treating a wire during drawing. A differentiation is made between induction annealers and resistance annealers.

In the electric continuous resistance annealing for wires, the (conductive) heat treating system of the drawing machine is connected immediately downstream of or integrated in the drawing machine, so that the wire passes through at the draw rate. In resistance annealing, the electric current used to heat the wire is fed to a wire section to be heated via contact disks or—in particular with multiwire annealing—through contact tubes. Contact tubes for resistance annealers are among the wear parts of wire production that are subject to high stresses. The surface quality thereof directly influences the quality of the products. As a result, for quality reasons they often must be replaced after only a few operating hours, notably in the finishing of fine wires.

Conventional designs for the contact tube clamping are constructed so that the contact tube is clamped between two flanges, which are braced by means of the shaft. The flanges must be produced from a material having the highest possible electrical conductivity, but also the highest possible strength. During the operation of the machine and when the power flow through the contact tube is activated, the contact tube heats up and expands in accordance with the material-specific longitudinal expansion coefficient. To this end, the preloaded outer retaining flange can be deformed not only elastically but also plastically, and the clamping of the contact tube declines.

The object of the present invention is to provide a solution that is powerful and flexible to as great an extent as possible for installing a contact tube in a continuous resistance annealer for wires. This object is achieved by an assembly, a device or a method according to any one of the independent claims.

The invention provides an assembly for attaching a contact tube to a shaft of a continuous resistance annealer for wires. A shaft-centered flange is provided at one end of this shaft, the flange comprising ring attachment structures for the shaft-centered attachment of a ring to this flange. This ring comprises tube attachment structures for the ring-centered attachment of the contact tube to this ring and flange attachment structures for the shaft-centered attachment of the ring to this flange.

In the method according to the invention for attaching a contact tube to a shaft of a continuous resistance annealer for wires, a corresponding assembly is set up. For this purpose, the contact tube is attached to the ring in a ring-centered manner by means of tube attachment structures. Subsequently, the ring is attached to the flange in a shaft-centered manner by means of the ring attachment structures and the flange attachment structures.

Advantageous refinements of the invention will be apparent from the dependent claims.

In conjunction with the invention, preferably tube attachment structures are used which are designed so that the contact tube is attached to, or can be attached to, the ring by a plurality of substantially axially oriented screws.

In conjunction with the invention, preferably ring attachment structures are used which are designed so that the ring is attached to, or can be attached to, the flange by a plurality of substantially axially oriented screws. Ring attachment structures that are particularly preferred are those which comprise structures for attaching stud screws and related nuts, wherein the ring and/or the flange are designed so that the stud screws slide into elongated holes of the ring after the contact tube, which is attached to the ring, has been slid on and after subsequent rotation of the ring.

Hereafter, the meanings of the terms contact tube, shaft, flange, ring, continuous resistance annealer for wires, shaft-centered, ring-centered, ring attachment structures, tube attachment structures, flange attachment structures, axially oriented screws, axial rotation, electrical heating, which are used in connection with the description of the present invention, will be described in more detail.

In conjunction with the description of the present invention, a contact tube shall be understood to mean a component of a continuous wire annealer that corresponds, at least in some sections, substantially to the shape of a straight circular cylinder, or to the mantle of such a circular cylinder, and comprises, at least in some areas, an electrically conductive surface, the component being used to introduce an electrical current into, or to discharge it from, a wire section to be heated. In multiwire annealers, a plurality of wires can be connected to a power source by means of a contact tube.

A shaft within the meaning of the description of the present invention is a—preferably substantially rod-shaped—machine part that can be rotated about a rotational axis for transmitting rotary movements or torque to a rotating machine element. In addition, a shaft can be utilized for current transmission.

In mechanical engineering, a flange is used to join various assemblies, preferably by means of screws and nuts. In addition to positioning the parts relative to one another, the function of the flanges is frequently also to transmit operating forces. In addition, a flange can be utilized for current transmission. Machine flanges are sometimes designed as passages for shafts, but can also be designed as pure attachment flanges without passages.

In conjunction with the description of the present invention, a ring shall be understood as a machine element which is designed so that it is suited to connect a tubular machine element, in particular a contact tube, to a flange. A ring within this meaning is also a preferably substantially circular ring-shaped or circular disk-shaped machine element having attachment structures, which are suited to attach the ring to a tubular machine part and to attach the ring to a flange. These attachment structures are preferably apertures or holes through which the attachment means, preferably screws, can be guided.

A continuous resistance annealer for wire (hereinafter also referred to as resistance annealer or continuous annealer) is a device for heat treating a wire passing through the resistance annealer by means of electrical current, which flows through sections of the wire passing through, more specifically between two contact tubes, and heats the wire based on the electrical resistance and the related heat development of the wire section. The resistance annealer is thus based on the principle of electrical resistance heating.

Within the meaning of the description of the present invention, a first machine element that can be rotated by a shaft is arranged in a shaft-centered manner relative to a second rotatable machine element, or to a shaft, when the rotational axis of the shaft coincides with the rotational axis of the first machine element.

A machine element that can be rotated about an axis is accordingly disposed in a ring-centered manner relative to a ring that can be rotated about an axis when both rotational axes coincide.

In connection with the description of the present invention, the term ring attachment structures shall denote structural characteristics of a machine element which enable or support an attachment of this machine element, for example a flange, to a ring within the meaning of the present invention, or the attachment of such a ring to this machine element. These are preferably apertures or holes through which the attachment means, preferably screws, can be guided.

In connection with the description of the present invention, the term tube attachment structures shall denote structural characteristics of a machine element, for example a ring within the meaning of the present invention, which enable or support an attachment of this machine element to a contact tube, or the attachment of such a contact tube to this machine element. These are preferably apertures or holes through which the attachment means, preferably screws, can be guided.

In connection with the description of the present invention, the term flange attachment structures shall denote structural characteristics of a machine element, for example a ring within the meaning of the present invention, which enable or support an attachment of this machine element to a flange, or the attachment of such a flange to this machine element. These are preferably apertures or holes through which the attachment means, preferably screws, can be guided.

The rotational axis of axially oriented screws is oriented substantially parallel to the rotational axis of a machine element to which these screws are affixed or are being affixed.

An axial rotation of a machine element denotes a rotation of this machine element about the rotational axis thereof. This can be a rotation about any arbitrary angle which is smaller than 360 degrees or greater than 360 degrees, or than a multiple of 360 degrees.

Electrical heating within the meaning of the present invention denotes a supply of heat which is fed from a heat development that is based on the electrical resistance of a material through which electrical current flows.

The invention will be described in more detail hereafter based on preferred embodiments and with the help of figures.

In the drawings:

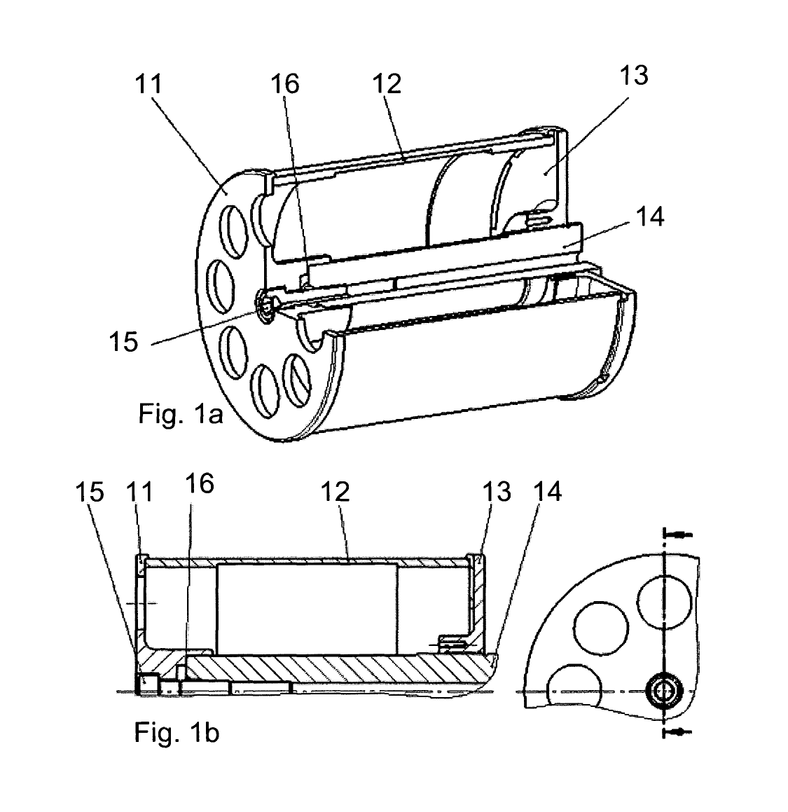

FIG. 1 is a known design for installing a contact tube in a resistance annealer, and

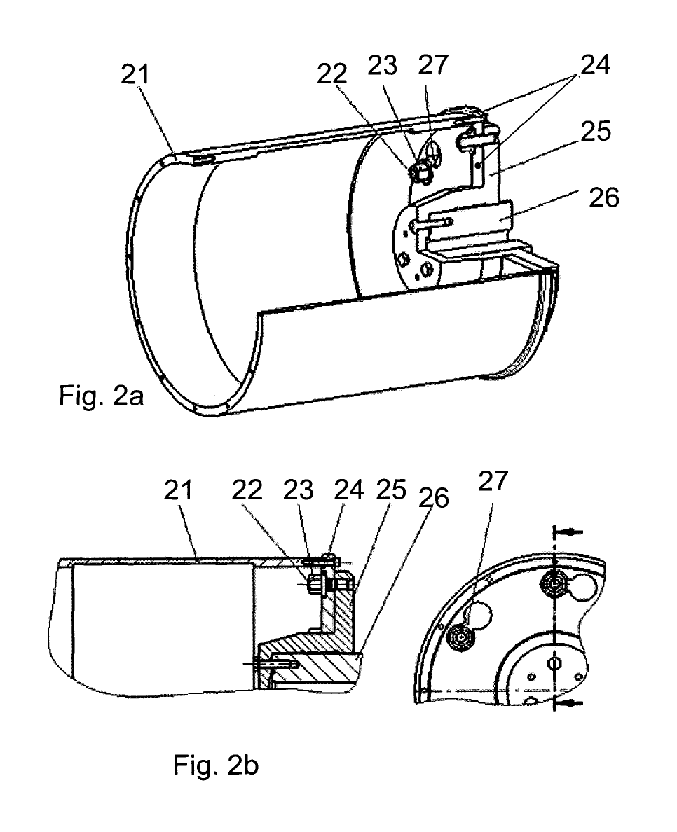

FIG. 2 is a preferred exemplary embodiment of a design according to the invention for installing a contact tube in a resistance annealer.

In continuous annealers for wire according to the conductive method, the current is transmitted to the wire via contact disks—in the case of multiwire annealers, this is done via contact tubes. The current is transmitted for this purpose by means of slip rings at the rear of the annealer through the shaft to the contact tube. In multiwire annealers, preferably contact tubes composed of copper tubes, pure nickel tubes or steel tubes having a nickel-plated surface are used. The contact tube material should be characterized by high electrical conductivity and high resistance against wear induced by abrasion and erosion.

Other requirements in regard to the design include:
a high degree of concentricity so as to avoid wire oscillations;
a low mass so as to be able to achieve the highest possible rotational speeds
ease of replaceability of the contact tube because the contact tube is a wear part.

FIG. 1 shows a known design for installing a contact tube in a resistance annealer. In this design, the contact tube 12 is guided between the rear flange 13 that is centered through the shaft 14 and the front cover 11 that is centered through the shaft. By tightening the central screw 15, which is screwed into the shaft, the front cover deforms in the axial direction and clamps the tube in place. The deformation of the front cover takes place in a defined manner via a stop 16 in the elastic range of the material.

FIG. 2 shows a preferred exemplary embodiment of a design according to the invention for installing a contact tube in a resistance annealer. The contact tube 21 is preferably screwed to a ring 24. The ring is centered on the flange 25, which is centered on and attached to the shaft 26. After the contact tube has been slid together with the ring onto the flange, in this embodiment of the invention the contact tube is rotated together with the ring axially relative to the flange. This type of attachment in accordance with the bayonet principle allows for particularly easy mounting when designed appropriately. Preferably stud screws 22 and nuts 23 are used to attach the ring to the flange. In this case, the stud screws 22, together with the nuts 23, slide into elongated holes 27 of the ring and fix the contact tube together with the ring on the flange. The ring together with the contact tube is braced against the flange by tightening the nuts on the stud screws attached in the flange.

According to the invention, the flange 25 comprises ring attachment structures which enable or support an attachment of this flange to the ring, or vice versa. These are preferably apertures or holes through which the attachment means, preferably screws, can be guided. Instead of screws and nuts, it is also possible to use screws having threads which engage in bores in the flange 25 or in the ring 24 that are provided with matching threads. A person skilled in the art will be able to select other possible attachment means depending on the requirements of the special application in question as needed.

The ring 24 generally comprises tube attachment structures which enable or support an attachment of the ring to a contact tube, or vice versa. These are preferably apertures or holes through which the attachment means, preferably screws, can be guided. These screws are then provided with a thread and preferably engage in bores in the mantle of the contact tube 21 that are provided with a matching thread.

The ring 24 additionally comprises flange attachment structures 27 which enable or support an attachment of the ring to a flange, or vice versa. These are preferably apertures or holes through which the attachment means, preferably screws, can be guided. Instead of screws and nuts, it is also possible to use screws having threads which engage in bores in the flange 25 or in the ring 24 that are provided with matching threads. A person skilled in the art will be able to select other possible attachment means depending on the requirements of the special application in question as needed.

Several exemplary embodiments of the invention have various advantages over the existing solution:
The contact tube can expand longitudinally without impairment when temperature raises, without resulting in mechanical stress. Thermally induced deformations of the design are therefore substantially excluded in these embodiments.
Compared to a central screw, the nuts are easier to tighten. They have lower tightening torque and facilitate the counter-holding during tightening. For this reason, installation by one person will often be possible.
The displacement of the masses in the direction of the bearing and the resulting effective (dynamic) shortening of the shaft cause an increase in the critical rotational speed of the shaft.

In several preferred embodiments, the design according to the invention is thus characterized in that the contact tube is only clamped on one side and thus a longitudinal expansion due to heating has no disadvantageous consequences. The development of unbalances due to the thermal deformations of components is substantially excluded in these embodiments. If the mass distribution is properly selected, a shorter cantilever is obtained. This allows higher permissible rotational speeds to be achieved. In addition, the concentricity quality of these embodiments is provided. In connection with these embodiments of the invention, it is thus also possible to employ materials for the contact tube that have a higher coefficient of expansion, yet also have higher electrical conductivity and a lower specific weight, for example aluminum.

Using screws and nuts as attachment means, several embodiments of the invention in particular support the need for fast replaceability of the contact tube. In addition, the option exists to leave the contact tube open on one side, as is shown in FIG. 2. Moreover, there is the option of closing the contact tube at the free end not connected to the shaft by using a cover. These embodiments of the assembly according to the invention would then look similar to the known solution in FIG. 1. However, they would differ from the same in that the cover would not be screwed to the shaft. These embodiments of the invention—which are not shown in the figures—would allow the advantages of these embodiments according to the invention to be combined with the known embodiment shown in FIG. 1.

1. An assembly for attaching a contact tube to a shaft of a continuous resistance annealer for wires, comprising: a shaft-centered flange is provided at one end of said shaft, the flange comprising ring attachment structures for the shaft-centered attachment of a ring to said flange, wherein said ring comprises tube attachment structures for the ring-centered attachment of the contact tube to said ring and flange attachment structures for the shaft-centered attachment of the ring to said flange.

2. The assembly according to claim 1, comprising tube attachment structures which are designed so that the contact tube is attachable to the ring by a plurality of substantially axially oriented screws.

3. An assembly according to claim 1, comprising ring attachment structures which are designed so that the ring is attachable to the flange by a plurality of substantially axially oriented screws.

4. The assembly according to claim 3, comprising ring attachment structures which comprise structures for attaching stud screws and related nuts, the ring and/or the flange being designed so that the stud screws slide into elongated holes of the ring after the contact tube, which is attached to the ring, has been slid on and after subsequent rotation of the ring.

5. A method for attaching a contact tube to a shaft of a continuous resistance annealer for wires, a shaft-centered flange being attached to one end of this shaft, the flange comprising ring attachment structures for the shaft-centered attachment of a ring to this flange, wherein this ring comprises tube attachment structures for the ring-centered attachment of the contact tube to this ring and flange attachment structures for the shaft-centered attachment of the ring to this flange, comprising the following steps:
a) attaching the contact tube to the ring in a ring-centered manner by means of tube attachment structures; and
b) attaching the ring to the flange in a shaft-centered manner by means of the ring attachment structures and the flange attachment structures.

6. The method according to claim 5, in which the ring attachment structures comprise stud screws and related nuts, wherein the stud screws slide into elongated holes of the ring after the contact tube, which is attached to the ring, has been slid on and after subsequent axial rotation of the ring.

7. A device for heat treating of wire by electrically heating the wire, comprising: at least one contact tube that is attached to a shaft for transmitting an electrical current to the wire, with the contact tube having been attached, or being attachable to the shaft.

8. A ring for attaching a contact tube to a shaft of a continuous resistance annealer for wires, a shaft-centered flange being attached to one end of the shaft, wherein said ring comprises tube attachment structures for the ring-centered attachment of the contact tube to said ring and flange attachment structures for the shaft-centered attachment of the ring to the flange.

9. The device according to claim 7, wherein the contact tube is attached to, or is attachable to said shaft by means of an assembly comprising: a shaft-centered flange is provided at one end of said shaft, the flange comprising ring attachment structures for the shaft-centered attachment of a ring to said flange, wherein said ring comprises tube attachment structures for the ring-centered attachment of the contact tube to said ring and flange attachment structures for the shaft-centered attachment of the ring to said flange.

10. The device according to claim 7, wherein the contact tube is attached to, or is attachable to said shaft using a method comprising the following steps:
a) attaching the contact tube to the ring in a ring-centered manner by means of tube attachment structures; and
b) attaching the ring to the flange in a shaft-centered manner by means of the ring attachment structures and the flange attachment structures.
